(19) United States
(12) Patent Application Publication
(10) Pub. No.: US 2018/0334953 A1
(43) Pub. Date: Nov. 22, 2018

(54) Linear Actuator Cable Linkage

(71) Applicant: BorgWarner Inc., Auburn Hills, MI (US)

(72) Inventor: Matthew Carson Colley, Arden, NC (US)

(73) Assignee: BorgWarner Inc., Auburn Hills, MI (US)

(21) Appl. No.: 15/596,601

(22) Filed: May 16, 2017

(51) Int. Cl. F02B 37/18; F16C 1/16; F16C 1/14; F16K 31/46

(52) U.S. Cl. CPC F02B 37/186; F16C 1/16; F01D 5/04; F16K 31/465; F16C 1/14

(57) ABSTRACT

A turbocharger assembly using exhaust gas flow to drive a turbine wheel in a turbine housing and having a wastegate valve assembly to control exhaust gas flow bypassing the turbine wheel. The turbocharger assembly includes a linear actuator operable to close the wastegate valve assembly and a flexible cable connecting the linear actuator to a lever of the wastegate valve assembly. The flexible cable is held in tension by interaction between the linear actuator and the wastegate valve assembly. The interaction between the linear actuator and the wastegate valve assembly includes the exhaust gas flow bypassing the turbine wheel and pulling the lever to open the wastegate valve assembly

### TECHNICAL FIELD

This disclosure relates to turbochargers, and more particularly, to turbochargers having a linear actuator with a cable linkage.

### BACKGROUND

Turbochargers are forced-induction devices that are utilized to increase the pressure of the intake air provided to the engine. Exhaust gases from the engine are routed to the turbocharger and are utilized to drive a turbine wheel. The rotational force generated by the turbine wheel is utilized to drive a compressor wheel, which pressurizes ambient intake air and supplies the pressurized intake air to the engine. By pressurizing the intake air, the amount of air and fuel that can be forced into each cylinder during an intake stroke of the engine is increased. This produces an increased power output relative to a naturally-aspirated engine.

When the pressure of the exhaust gas is high, there may be more exhaust pressure than is required to provide the desired ambient air pressure. One solution for this problem is to divert exhaust gas away from the turbine wheel when the exhaust gas pressure is high, so that the amount of exhaust gas reaching the turbine is the quantity needed to provide the desired ambient air pressure.

A wastegate valve may be used to divert exhaust gases away from the turbine wheel. Diversion of exhaust gases controls the turbine speed, which in turn controls the rotational speed of the compressor wheel. By controlling the rotational speed of the compressor wheel, the wastegate valve is able to regulate the maximum ambient air pressure in the turbocharger. Some conventional turbochargers use a wastegate control assembly to control the wastegate valve. For example, the wastegate control assembly causes the wastegate valve to open when exhaust gas pressure is high, and close when exhaust gas pressure drops. The wastegate valve can be controlled based on the pressure of the exhaust gas entering the turbocharger.

In some previously known embodiments, and as is generally illustrated in FIG. 2, a wastegate control assembly 200 may include an actuator 130, such as an electric linear actuator. The actuator 130 may be in mechanical communication with the wastegate valve 124, as is generally illustrated in FIG. 1. The actuator may be coupled and/or connected to a linkage. The linkage may include a multi-piece linkage 208 having a bolted joint 212, one or more pin connectors 224, 230, an L-bracket 210, a dog bone link 218, other coupling and/or connecting devices, or a combination thereof. The components of the multi-piece linkage 208 may cooperatively operate to allow a wastegate lever 206 to travel (e.g., to open the wastegate valve 124) in an arc without imparting any side loading onto an actuator shaft 202, which is fixed rigidly in the actuator 130 and restricted to linear movement.

The multi-piece linkage 208 can be susceptible to mechanical wear over time and may require maintenance to avoid damage to the actuator 130, the multi-piece linkage 208, the wastegate lever 206, the wastegate valve 124, or a combination thereof. Additionally, or alternatively, various components of the multi-piece linkage 208 may be susceptible to mechanical noise, vibration, and/or harshness due in part to, for example, components rattling against one another. Accordingly, noise, vibration, and/or harshness reduction devices, such as anti-rattle springs, may be added to the multi-piece linkage 208 in order to achieve desirable noise, vibration, and harshness levels associated with the multi-piece linkage 208. However, such additional noise, vibration, and/or harshness reduction devices add components to the multi-piece linkage 208 thereby adding cost and possible maintenance issues to the multi-piece linkage 208.

Accordingly, a linkage that maintains operating characteristics of the multi-piece linkage 208 and that is less susceptible to mechanical wear, noise, vibration, harshness, and/or a combination thereof may be desirable.

### SUMMARY

Disclosed herein are aspects, features, elements, implementations, and embodiments of linear actuators having a cable linkage.

An aspect of the disclosed embodiments is a turbocharger assembly using exhaust gas flow to drive a turbine wheel in a turbine housing and a wastegate valve assembly to control exhaust gas flow bypassing the turbine wheel. The turbocharger assembly includes a linear actuator operable to close the wastegate valve assembly and a flexible cable connecting the linear actuator to a lever of the wastegate valve assembly. The flexible cable is held in tension by interaction between the linear actuator and the wastegate valve assembly. The interaction between the linear actuator and the wastegate valve assembly includes the exhaust gas flow bypassing the turbine wheel and pulling the lever to open the wastegate valve assembly.

Another aspect of the disclosed embodiments is a wastegate control assembly for controlling exhaust gas flow bypassing a turbine wheel of a turbocharger. The wastegate control assembly includes a wastegate valve assembly adapted to open when exhaust gas pressure within the turbocharger exceeds a threshold. The wastegate control assembly further includes a wastegate lever rotatably coupled to the wastegate valve assembly, wherein the wastegate lever is moveable between a first position when the wastegate valve assembly is closed and a second position when the wastegate valve assembly is open. The wastegate control assembly further includes a linear actuator having an actuator shaft. The linear actuator is operable to retract the actuator shaft to close the wastegate valve assembly. The wastegate control assembly further includes a flexible cable connecting the actuator shaft to the wastegate lever, wherein the flexible cable is held in tension by interaction between the actuator shaft and the wastegate lever.

Another aspect of the disclosed embodiments is a system for closing a wastegate valve assembly. The system includes a wastegate lever rotatably coupled to the wastegate valve assembly, the wastegate assembly adapted to open when exhaust gas pressure within a turbocharger exceeds a threshold, wherein the wastegate lever is moveable along a non-linear path between a first position when the wastegate valve assembly is closed and a second position when the wastegate valve assembly is open. The system further includes a linear actuator having an actuator shaft. The linear actuator is operable to retract the actuator shaft to close the wastegate valve assembly. The system further includes a flexible cable having a proximal end coupled to the actuator shaft and a distal end coupled to the wastegate lever. The flexible cable is held in tension by interaction between the actuator shaft and the wastegate lever and the flexible cable is adapted to flex as the wastegate lever moves along the non-linear path.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 generally illustrates a perspective partial cross-section view of a turbocharger according to the prior art.

FIG. 2 generally illustrates a wastegate control assembly according to the prior art.

FIG. 3 generally illustrates a wastegate control assembly including a cable linkage according to the principles of the present disclosure.

FIG. 4 generally illustrates an alternative wastegate control assembly including a cable linkage according to the principles of the present disclosure.

### DETAILED DESCRIPTION

As described above, a wastegate control assembly that utilizes a multi-piece linkage, can be susceptible to mechanical wear over time and may require maintenance to avoid damage to an associated actuator, the multi-piece linkage, an associated wastegate lever, an associated wastegate valve, or a combination thereof. Additionally, or alternatively, various components of the multi-piece linkage may be susceptible to mechanical noise, vibration, and/or harshness due in part to, for example, components rattling against one another. Noise, vibration, and/or harshness reduction devices, such as anti-rattle springs, may be added to such a multi-piece linkage in order to achieve desirable noise, vibration, and harshness levels associated with the multi-piece linkage. However, the addition of such noise, vibration, and/or harshness reduction devices may add cost and/or maintenance issues to the multi-piece linkage.

Accordingly, a linkage that maintains operating characteristics of the multi-piece linkage and that is less susceptible to mechanical wear, noise, vibration, harshness, and/or a combination thereof may be desirable. According to the principles of the present disclosure, such a linkage may include a flexible cable disposed between an associated actuator shaft and an associated wastegate level that allows the wastegate lever to travel in a non-liner pattern while allowing the actuator shaft to travel linearly with respect to an associated actuator.

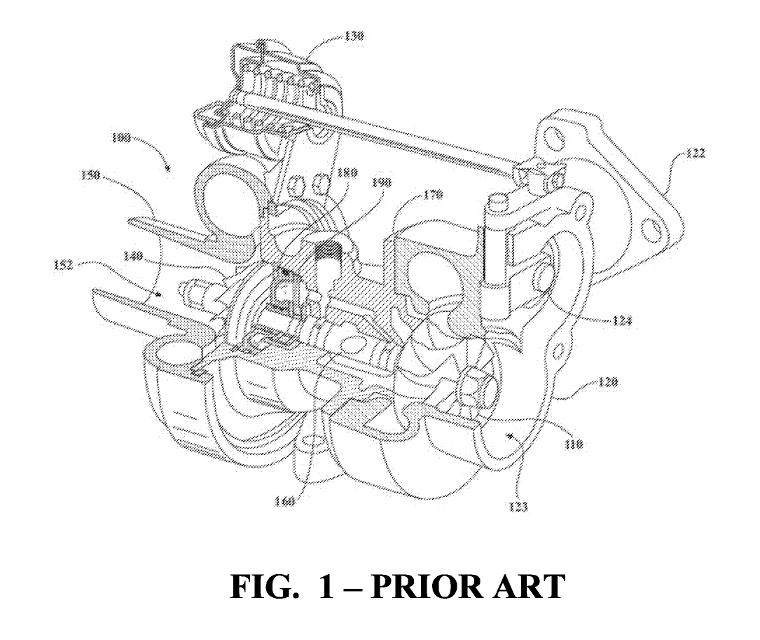

FIG. 1 shows a turbocharger 100 according to the prior art that is an exhaust-gas driven forced induction device that is utilized in conjunction with an internal combustion engine (not shown). The turbocharger 100 includes a turbine wheel 110 located in a turbine housing 120. The turbine housing 120 includes an exhaust gas inlet 122 for receiving exhaust gas from the internal combustion engine. Exhaust gases are routed from the exhaust gas inlet 122 to the turbine wheel 110 before exiting the turbine housing 120 at an exhaust gas outlet 123.

A wastegate valve 124 may be mounted in the turbine housing 120 to allow some or all of the exhaust gas to bypass the turbine wheel 110. For example, the wastegate valve 124 is adapted to divert exhaust gases away from the turbine wheel 110. The diversion of exhaust gases may be used to control turbine speed, which in turn controls a rotational speed of the compressor wheel 140. By controlling the rotational speed of the compressor wheel 140, the wastegate valve 124 can regulate the maximum ambient air pressure in the turbocharger 100. In some embodiments, a wastegate control assembly is adapted to open and close the wastegate valve 124. The wastegate control assembly, as will be described in detail below, causes the wastegate valve 124 to open when exhaust gas pressure is high and close when exhaust gas pressure drops. For example, the wastegate control assembly includes an actuator 130. The actuator 130 may include an electric actuator, a mechanical actuator, a pneumatic actuator, a hydraulic actuator, or other suitable actuator. The actuator 130 is adapted to move the wastegate valve 124 between an open position when exhaust gas pressure is high and a closed position when exhaust gas pressure drops.

The turbocharger 100 includes a compressor wheel 140 located in a compressor housing 150. The compressor housing 150 includes an intake air inlet 152 and an intake air outlet (not shown). Intake air is routed from the intake air inlet 152 to the compressor wheel 140, where the intake air is pressurized by rotation of the compressor wheel 140. The intake air then exits the compressor housing 150 at the intake air outlet before being supplied to the internal combustion engine.

Rotation of the compressor wheel 140 is driven by rotation of the turbine wheel 110. In particular, the turbine wheel 110 and the compressor wheel 140 are each connected to a shaft 160. The shaft 160 can be a substantially rigid member, and each of the turbine wheel 110 and the compressor wheel 140 can be connected to the shaft 160 in a manner that prevents rotation of the turbine wheel 110 and the compressor wheel 140 with respect to the shaft 160. As a result, the compressor wheel 140 can rotate in unison with the turbine wheel 110 in response to rotation of the turbine wheel 110.

The shaft 160 is supported within a bearing housing 170 such that the shaft 160 can rotate freely with respect to the bearing housing 170 at a very high rotational speed. The bearing housing 170, the turbine housing 120, and the compressor housing 150 are all arranged along an axis of rotation of the shaft 160. In particular, the bearing housing 170 is positioned between the turbine housing 120 and the compressor housing 150, with a first end of the bearing housing 170 connected to the turbine housing 120 and a second end of the bearing housing 170 connected to the compressor housing 150. The bearing housing 170 can incorporate lubrication and/or cooling features.

The bearing housing 170 defines a cavity, which contains the shaft 160 and a thrust hearing 190. The cavity may be closed by an oil seal plate 180 (e.g., cover, closure, etc.). The shaft 160, the thrust bearing 190, and the oil seal plate 180 function to cooperatively transfer axial force (e.g., axial loading) from the turbine wheel 110 to the bearing housing 170 and, thereby, locate the shaft 160 axially relative to the bearing housing 170. The axial force may be a result of the pressure imbalance between the turbine housing 120 (e.g., at higher pressure) and the compressor housing 150 (e.g., at lower pressure), which applies a net axial force on the shaft 160 in the axial direction moving from the turbine wheel 110 to the compressor wheel 140.

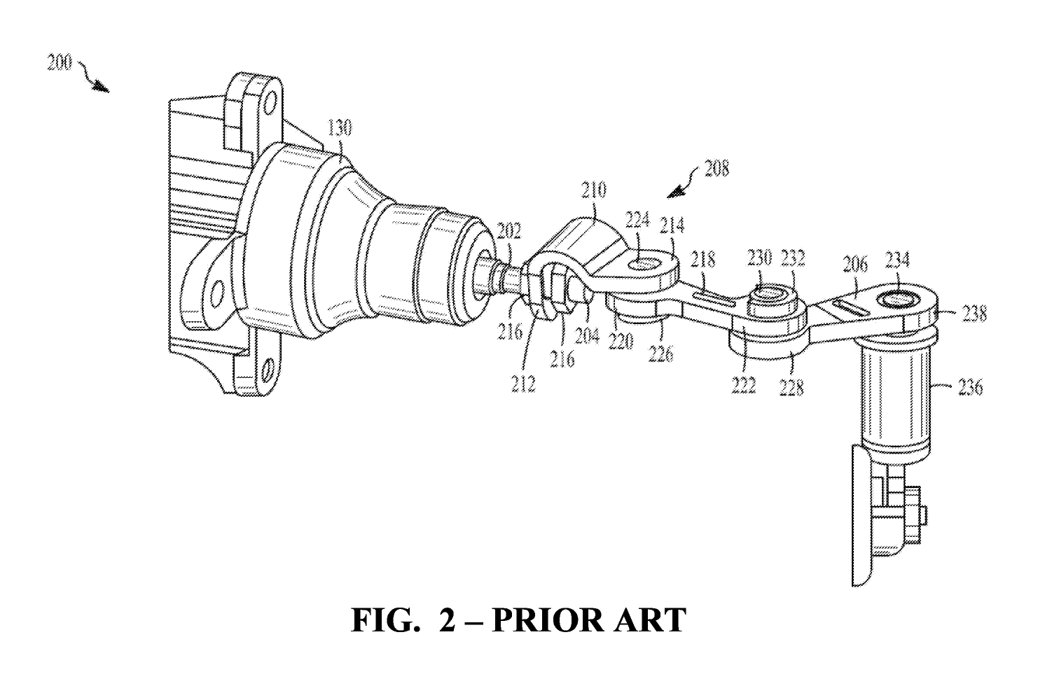

FIG. 2 generally illustrates a wastegate control assembly 200 according to the prior art. The wastegate control assembly 200 includes an actuator, such as the actuator 130 of FIG. 1. The actuator 130 may include an electric actuator, a mechanical actuator, a pneumatic actuator, a hydraulic actuator, or other suitable actuator. In some embodiments, the actuator 130 includes an electric linear actuator. For example, the actuator 130 is adapted to utilize electric power to create substantially linear motion.

The actuator 130 includes an actuator shaft 202 having a rigid member adapted to extend linearly from the actuator 130. The actuator shaft 202 includes a first end (not shown) disposed within the actuator 130. The first end of the actuator shaft 202 may be attached, coupled, and/or connected to a moveable portion of the actuator 130. For example, the first end of the actuator shaft 202 may be attached, coupled, and/or connected to a piston (not shown) within the actuator 130. The actuator shaft 202 includes a second end 204 disposed on an opposite end of the actuator shaft 202 from the first end of the actuator shaft 202.

The actuator 130 receives electric power from a power source, such as a battery. The electric power is converted to mechanical energy. The mechanical energy is used to actuate the moveable portion of the actuator 130. For example, the mechanical energy is used to move the piston within the actuator 130. The moveable portion of the actuator 130, when moved, causes the actuator shaft 202 to extend or retract substantially linearly relative to the actuator 130. For example, when the moveable portion of the actuator 130 is moved in a first direction, the actuator shaft 202 extends linearly away from the actuator 130. Conversely, when the moveable portion of the actuator 130 is moved in a second direction opposite the first direction, the actuator shaft 202 retracts linearly toward the actuator 130. The actuator shaft 202 may be fully extended, partially extended, fully retracted, or partially retracted based on an amount of mechanical energy applied to the moveable portion of the actuator 130.

In some embodiments, the actuator 130 includes a pull-type electric linear actuator. For example, the actuator 130 is adapted to pull the actuator shaft 202 in a retracted position and to resist the extension of the actuator shaft 202. An external force may act on the actuator shaft 202 in order to overcome the actuator 130 to extend the actuator shaft 202 away from the actuator 130. As the external force acting on the actuator shaft 202 is reduced, the actuator 130 pulls the actuator shaft 202 into the retracted position.

The wastegate control assembly 200 includes a wastegate lever 206 attached, coupled, and/or connected to a wastegate valve assembly, such as the wastegate valve 124 in FIG. 1. The wastegate lever 206 is adapted to open and close the wastegate valve 124. For example, when exhaust pressure within the turbocharger 100 is below a threshold (e.g., low), the wastegate valve 124 remains closed, and the wastegate lever 206 is in a first position. When the wastegate lever 206 is in the first position, at least a portion of the wastegate valve 124 covers an opening, such that, the wastegate valve 124 is closed, and exhaust is not diverted away from the turbocharger 100 through the wastegate valve 124. Conversely, when the exhaust pressure within the turbocharger 100 is above the threshold (e.g., high), the exhaust pressure causes the wastegate valve 124 to open and the wastegate lever 206 to move to a second position. When the wastegate lever 206 is in the second positon, the wastegate valve 124 is open, and exhaust gas is diverted from the turbocharger 100 through the opening of the wastegate valve 124.

In some embodiments, the actuator 130 is operable to close the wastegate valve 124. For example, the actuator shaft 202 is in mechanical communication with the wastegate lever 206. As described above, the actuator 103 may include a pull-type actuator that is operable to bias the actuator shaft 202 in the retracted position. When the actuator shaft 202 is in the retracted position, a retraction force generated by the actuator 130, and transferred through the actuator shaft 202, acts on the wastegate lever 206. The wastegate lever 206 is held in the first position (e.g., closing the wastegate valve 124) in response to the retraction force.

Additionally, or alternatively, when the exhaust pressure within turbocharger 100 increases, an extension force acts on the wastegate lever 206. When the exhaust pressure increases above the threshold, the extension force coincidentally increases. The extension force is transferred through the wastegate lever 206 and acts on the actuator shaft 202. When the extension force is less than the retraction force, the actuator shaft 202 remains in the retracted position and the wastegate lever 206 remains in the first position. When the extension force is greater than the retraction force, the wastegate lever 206 is moved into the second position causing the actuator shaft 202 to move into an extended position. The exhaust is diverted away from the turbocharger 100 through the opening of the wastegate valve 124. As the exhaust is diverted, exhaust pressure within the turbocharger 100 decreases. The extension force decreases in response to the exhaust pressure decreasing. When the extension force is again less than the retraction force, the retraction force causes the actuator shaft 202 to move to the retracted position. The actuator shaft 202 acts on the wastegate lever 206 to move the wastegate lever 206 to the first position (e.g., closing the wastegate valve 124).

In some embodiments, wastegate control assembly 200 includes a multi-piece linkage 208. The multi-piece linkage 208 is adapted to cooperatively operate with the actuator shaft 202 and the wastegate lever 206 to allow the wastegate lever 206 to travel (e.g., to open the wastegate valve 124) in an arc without imparting any side loading onto the actuator shaft 202, which is fixed rigidly in the actuator 130 and restricted to linear movement.

The multi-piece linkage 208 is disposed between the actuator shaft 202 and the wastegate lever 206. The multi-piece linkage 208 includes a bracket 210 having an L-shaped bracket or another suitable bracket. The bracket 210 includes a first end 212 and a second end 214. The bracket 210 is attached, coupled, and/or connected to the second end 204 of the actuator shaft 202. For example, the multi-piece linkage 208 includes one or more fasteners 216. The fasteners 216 may include threaded nuts, washers, other suitable fasteners, and/or a combination thereof.

In some embodiments, the second end 204 of the actuator shaft 202 includes threads adapted to receive a first fastener 216 which is threaded onto the second end 204 of the actuator shaft 202. The first end 212 of the bracket 210 includes a bore adapted to allow the second end 204 of the actuator shaft 202 to pass through the first end 212. A second fastener 216 is threaded onto the second end 204 of the actuator shaft 202, such that, the first end 212 of the bracket 210 is secured to the second end 204 of the actuator shaft 202.

The second end 214 of the bracket 210 is attached, coupled, and/or connected to a link 218. The link 218 may include a dog bone link or other suitable link. The link 218 includes a first end 220 and a second end 222. The second end 214 of the bracket 210 is attached, coupled, and/or connected to the first end 220 of the link 218. For example, a pin 224 is adapted to pass through a bore disposed in a surface of the second end 214 of the bracket 210 and through a bore disposed in a surface of the first end 220 of the link 218. The pin 224 includes a pin head having a diameter that is wider than a diameter of the bore disposed in the surface of the second end 214 of the bracket 210, such that, the pin head prevents the pin 224 from passing through the bracket 210. A clip 226 is adapted to secure the pin 224 to the bracket 210 and the link 218 while allowing the bracket 210 and the link 218 to rotate about the pin 224. For example, the clip 226 engages a portion of the pin 224 opposite the pin head. The clip 226 prevents withdrawal of the pin 224 from the bracket 210 and/or the link 218. The clip 226 may include a c-clip, an e-clip, or other suitable clip. The pin 224 is adapted to receive the clip 226.

The second end 222 of the link 218 is attached, coupled, and/or connected to a first end 228 of the wastegate lever 206. For example, a pin 230 is adapted to pass through a bore disposed in a surface of the second end 222 of the link 218 and through a bore disposed in a surface of the first end 228 of the wastegate lever 206. The pin 230 includes a pin head having a diameter that is wider than a diameter of the bore disposed in the surface of the second end 222 of the link 218, such that, the pin head prevents the pin 230 from passing through the link 218. One or more clips 232 are adapted to secure the pin 230 to the link 218 and the wastegate lever 206 while allowing the link 218 and the wastegate lever 206 to rotate about the pin 230. For example, a first clip 232 engages a portion of the pin 230 proximate the pin head. In some embodiments, a second clip 232 engages a portion of the pin 230 opposite the pin head. The clips 232 prevent withdrawal of the pin 230 from the link 218 and/or the wastegate lever 206. The clips 232 may include c-clips, e-clips, or other suitable clips. The pin 230 is adapted to receive the one or more clips 232.

In some embodiments, the wastegate lever 206 is secured to a bushing 236. The bushing 236 is in mechanical communication with the wastegate valve 124. The wastegate lever 206 includes a second end 238. The second end 238 of the wastegate lever 206 is attached, coupled, and/or connected to the bushing 236 by a connector 234. The connector 234 may include a pin, a rivet, a weld join, or other suitable connector. As exhaust pressure within the turbocharger 100 exceeds the threshold, as described above, the wastegate valve 124 opens allowing exhaust to be diverted away from the turbocharger 100. When the wastegate valve 124 is open, the wastegate valve 124 acts on the bushing 236. The bushing 236 is adapted to turn, rotate, translate, and/or otherwise cause to the wastegate lever 206 to move from the first position to the second position, as described above.

The wastegate lever 206 rotates around the connector 234 in response to the bushing 236 acting on the wastegate lever 206. As the wastegate lever 206 rotates, the first end 228 of the wastegate lever 206 travels in a generally non-linear path. For example, the first end 228 of the wastegate lever 206 travels in an arc with respect to a starting point of the first end 228 of the wastegate lever 206. As the wastegate lever 206 travels in a generally non-linear path, the components of the multi-piece linkage 208 translate about the pin 224 and the pin 230. For example, the link 218 may move substantially 3 millimeters transversally about the pin 230 and the pin 224. As the link 218 translates about the pin 224 and the pin 230, the bracket 210 acts on the actuator shaft 202, such that, the actuator shaft 202 is pulled linearly into the extended position without the wastegate lever 206 imparting side loading onto the actuator shaft 202.

As described above, as the exhaust pressure within the turbocharger 100 decreases, the actuator shaft 202 returns to the retracted position. As the actuator shaft 202 returns to the retracted position, the actuator shaft 202 acts on the bracket 210. The bracket 210 acts on the link 218, which translates on the pin 224 and the pin 230, acting on the wastegate lever 206, such that, the wastegate lever 206 is returned to the first position (e.g., closing the wastegate valve 124).

As described above, the multi-piece linkage 208 may be susceptible to mechanical wear. For example, the pin 224 may be susceptible to mechanical wear as the respective components of the multi-piece linkage 208 rotate and/or translate about the pin 224. Consequently, the components of the multi-piece linkage 208 may comprise high grade, relatively expensive, materials, such as high grade stainless steel, in order to reduce mechanical wear. Additionally, or alternatively, the link 218 may rattle against the bracket 210 and/or the wastegate lever 206, which may result in undesirable noise, vibration, and harshness levels. Consequently, additional components may be required to control noise, vibration, and harshness which may lead to additional cost and maintenance issues. Further, the clip 226 and the clip 232 may be difficult to install during assembly of the multi-piece linkage 208. Additionally, or alternatively, the fasteners 216 may loosen overtime and require maintenance in order to prevent damage to the actuator 130, the actuator shaft 202, the multi-piece linkage 208, the wastegate lever 206, the bushing 236, the wastegate valve 124, and/or a combination thereof.

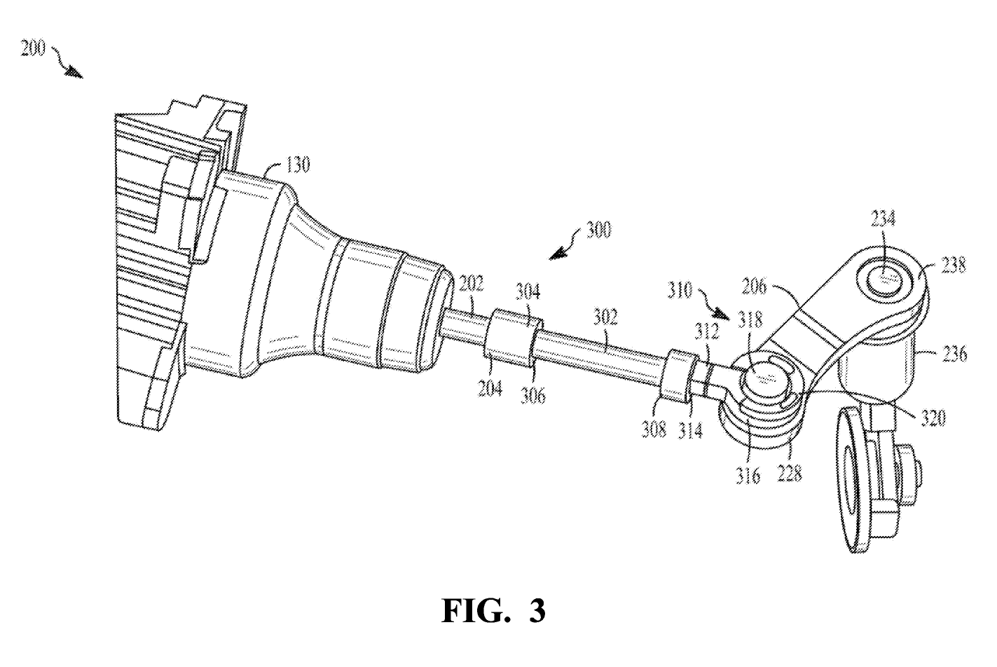

FIG. 3 generally illustrates a wastegate control assembly, such as the wastegate control assembly 200, including a cable linkage 300 according to the principles of the present disclosure. The cable linkage 300 may be less susceptible to mechanical wear and may be less difficult to assemble than the multi-piece linkage 208 while maintaining the functionality of the multi-piece linkage 208. For example, the cable linkage 300 is adapted to cooperatively operate with the actuator shaft 202 and the wastegate lever 206 to allow the wastegate lever 206 to travel (e.g., to open the wastegate valve 124) in an arc without imparting any side loading onto the actuator shaft 202, which is fixed rigidly in the actuator 130 and restricted to linear movement.

The cable linkage 300 includes a cable 302 which may include a flexible cable comprising braided steel. In some embodiments, the cable 302 may include a semi-rigid cable comprising a rubber cable, a polymer cable, or other suitable cable. The cable 302 includes a proximal or first end 306. The first end 306 of the cable 302 is attached, coupled and/or connected to the second end 204 of the actuator shaft 202. For example, the cable linkage 300 may include a connector 304 comprising a ferrule connector, a crimp connector, a threaded barrel connector, or another suitable connector.

The connector 304 is adapted to receive a portion of the second end 204 of the actuator shaft 202 and a portion of the first end 306 of the cable 302. A first side of the connector 304 is attached, coupled, and/or connected to the second end 204 of the actuator shaft 202. For example, the first side of the connector 304 may be crimped onto a portion of the second end 204 of the actuator shaft 202, threaded onto the portion of the second end 204 of the actuator shaft 202, welded onto the portion of the second end 204 of the actuator shaft 202, and/or attached, coupled, and/or connected to the portion of the second end 204 of the actuator shaft 202 in another suitable fashion. A second side of the connector 304 disposed opposite the first side of the connector 304 is attached, coupled, and/or connected to the first end 306 of the cable 302. For example, the second side of the connector 304 may be crimped onto the first end 306 of the cable 302, threaded onto the first end 306 of the cable 302, welded onto the first end 306 of the cable 302, and/or attached, coupled, and/or connected to the first end 306 of the cable 302 in another suitable fashion.

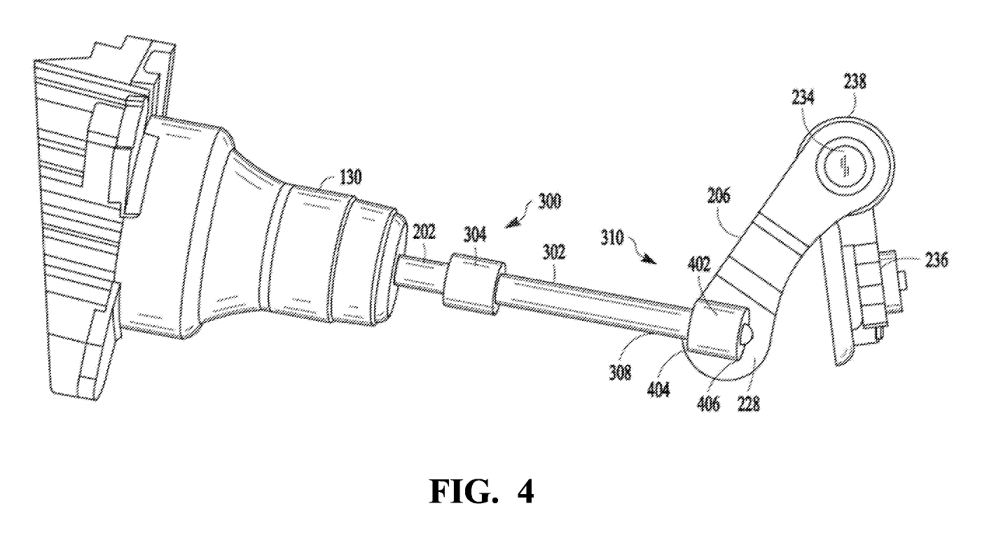

The cable 302 includes a distal or second end 308 disposed on an opposite side of the cable 302 from the first end 306 of the cable 302. In some embodiments, the second end 308 is attached, coupled, and/or connected to the first end 228 of the wastegate lever 206. For example, the cable linkage 300 includes a connector assembly 310. In some embodiments, the connector assembly 310 includes a ferrule connector, a crimp connector, a threaded barrel connector, or other suitable connector. For example, as is generally illustrated in FIG. 4, the connector assembly 310 includes a ferrule connector 402. The connector assembly 310 may be attached, coupled, and/or connected to the second end 308 of the cable 302, as described above with respect to the connector 304. For example, the second end 308 of the cable 302 may be inserted and secured in a first end 404 of the ferrule connector 402. The connector assembly 310 may be attached, coupled, and/or connected to the first end 228 of the wastegate lever 206. For example, the ferrule connector 402 may be welded at a second end 406 of the ferrule connector 402 to a surface portion of the first end 228 of the wastegate lever 206.

In some embodiments, the connector assembly 310 includes a fitting 312, as seen in FIG. 3. The fitting 312 may include a swaged fitting, an eye fitting, or other suitable fitting. For example, the fitting 312 may include a swaged fitting including a connector end 314. The connector end 314 is adapted to receive a portion of the second end 308 of the cable 302. For example, the portion of the second end 308 of the cable 302 may be threaded into the connector end 314, crimped into the connector end 314, welded onto the connector end 314, and/or attached, coupled, and/or connected to the connected end 314 in another suitable fashion.

The connector assembly 310 includes a loop or eye end 316 disposed opposite the connector end 314. The eye end 316 includes a through bore extending through a surface of the eye end 316. The connector assembly 310 includes a pin 318 which is received by the bore in the surface of the eye end 316. The pin 318 passes through the bore disposed in the surface of the eye end 316 into the bore disposed in the surface of the first end 228 of the wastegate lever 206, as described above with respect to FIG. 2. The pin 318 includes a pin head having a diameter that is larger than a diameter of the bore disposed in the surface of the eye end 316, such that, the pin head prevents the pin 318 from passing through the eye end 316. The eye end 316 is adapted to rotate about the pin 318.

The connector assembly 310 includes one or more clips 320. The one or more clips 320 are adapted to secure the pin 318 to the eye end 316 and the first end 228 of the wastegate lever 206 while allowing the eye end 316 and the first end 228 of the wastegate lever 206 to rotate about the pin 318. For example, a first clip 320 engages a portion of the pin 318 proximate the pin head. In some embodiments, a second clip (not shown) may engage a portion of the pin 318 opposite the pin head. The one or more clips 320 prevent withdrawal of the pin 318 from the eye end 316 and/or the first end 228 of the wastegate lever 206. The one or more clips 320 may include c-clips, e-clips, or other suitable clips. The pin 318 is adapted to receive the one or more clips 320.

The cable 302 is held in tension by the interaction between the actuator shaft 202 and the wastegate lever 206. As described above, when the wastegate valve 124 is closed, the wastegate lever 206 is in the first position, and the actuator shaft 202 is in the retracted position. The cable 302 is held in tension between the wastegate lever 206 and the actuator shaft 202 when the wastegate lever 206 is in the first position, and the actuator shaft 202 is in the retracted position. When the wastegate valve 124 is open (e.g., as a result of exhaust pressure within the turbocharger 100 exceeding the threshold), the wastegate lever 206 is moved to the second position. The wastegate lever 206 acts on the cable 302. For example, as described above, an extension force may be generated by the wastegate lever 206, and the extension force may act on the cable 302. When the extension force exceeds the retraction force holding the actuator shaft 202 in the retracted position, the actuator shaft 202 extends in response to the extension force. The cable 302 is held in tension between the wastegate lever 206 and the actuator shaft 202 as the wastegate lever 206 moves into the second position and when the wastegate lever 206 is in the second position.

As the exhaust is diverted through the wastegate valve 124, the extension force decreases. As the retraction force exceeds the extension force, the retraction force acts on the actuator shaft 202 to retract the actuator shaft 202 back to the retracted position. The actuator shaft 202 acts on the cable 302. The cable 302 acts on the wastegate lever 206, such that, when the actuator shaft 202 returns to the retracted position, the cable 302 pulls the wastegate lever 206 back to the first position (e.g., closing the wastegate valve 124). The cable 302 is held in tension between the actuator shaft 202 and the wastegate lever 206 as the actuator shaft 202 returns to the retracted position and as the wastegate lever 206 returns to the first position.

As described above with respect to FIG. 2, the first end 228 of the wastegate lever 206 travels in a generally non-linear path, such as an arc, with respect to a starting point of the first end 228 of the wastegate lever 206. The cable 302 is adapted to cooperatively operate with the actuator shaft 202 and the wastegate lever 206 to allow the wastegate lever 206 to travel (e.g., to open the wastegate valve 124) in an arc without imparting any side loading onto the actuator shaft 202, which is fixed rigidly in the actuator 130 and restricted to substantially linear movement. For example, as the wastegate lever 206 travels between the first position and the second position, the cable 302 deforms and/or flexes. As the cable 302 deforms and/or flexes, the wastegate lever 206 can travel in the non-linear path while the actuator shaft 202 travels substantially linearly with respect to the actuator 130.

As used herein, the terminology “or” is intended to mean an inclusive “or” rather than an exclusive “or”. That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A turbocharger assembly using exhaust gas flow to drive a turbine wheel (110) in a turbine housing (120) and having a wastegate valve assembly (124) to control exhaust gas flow bypassing the turbine wheel (110), the turbocharger assembly (100) comprising:
a linear actuator (130) operable to move the wastegate valve assembly (124) between an open and closed position; and
a flexible cable (302) connecting the linear actuator (130) to a lever (206) of the wastegate valve assembly (124),
wherein the flexible cable (302) is held in tension by an interaction between the linear actuator (130) and the wastegate valve assembly (124), and
wherein the interaction between the linear actuator (130) and the wastegate valve assembly (124) includes the exhaust gas flow bypassing the turbine wheel (110) and pulling the lever (206) to move the wastegate valve assembly (124) into the open position.

2. The turbocharger assembly of claim 1, wherein the interaction between the linear actuator (130) and the wastegate valve assembly (124) includes the linear actuator (130) pulling the lever (206) to move the wastegate valve assembly (124) into the closed position.

3. The turbocharger assembly of claim 1, wherein the linear actuator (130) includes an electric linear actuator (130).

4. The turbocharger assembly of claim 1, wherein the linear actuator (130) includes an actuator shaft (202) coupled to a proximal end (306) of the flexible cable (302).

5. The turbocharger assembly of claim 4, the flexible cable (302) includes a ferrule connector (304) disposed at the proximal end (306) of the flexible cable (302) wherein the ferrule connector (304) is coupled to the actuator shaft (202).

6. The turbocharger assembly of claim 1, wherein the flexible cable (302) is coupled to the lever (206) at a distal end (308) of the flexible cable (302).

7. The turbocharger assembly of claim 6, wherein the distal end (308) of the flexible cable (302) includes a swaged fitting (312) adapted to couple the distal end (308) of the flexible cable (302) to the lever (206).

8. The turbocharger assembly of claim 7, wherein the swaged fitting (312) is adapted to rotate about a pin (318) adapted to couple the swaged fitting (312) to the lever (206).

9. The turbocharger assembly of claim 1, wherein the flexible cable (302) includes a ferrule connector (304) disposed at a distal end (308) of the flexible cable (302) and wherein the ferrule connector (304) is welded to the lever (206).

10. A wastegate control assembly for controlling exhaust gas flow bypassing a turbine wheel (110) of a turbocharger (100), the wastegate control assembly comprising:
a wastegate valve assembly (124) adapted to open to a second position when exhaust gas pressure within the turbocharger (100) exceeds a threshold;
a wastegate lever (206) rotatably coupled to the wastegate valve assembly (124), wherein the wastegate lever (206) is moveable between a first position when the wastegate valve assembly (124) is closed and the second position when the wastegate valve assembly (124) is open;
a linear actuator (130) having an actuator shaft (202), the linear actuator (130) being operable to retract the actuator shaft (202) to close the wastegate valve assembly (124) in the first position; and
a flexible cable (302) connecting the actuator shaft (202) to the wastegate lever (206), wherein the flexible cable (302) is held in tension by interaction between the actuator shaft (202) and the wastegate lever (206).

11. The wastegate control assembly of claim 10, wherein the linear actuator (130) includes an electric linear actuator (130).

12. The wastegate control assembly of claim 10, the flexible cable (302) includes a ferrule connector (304) disposed at a proximal end (306) of the flexible cable (302) and wherein the ferrule connector (304) is coupled to the actuator shaft (202).

13. The wastegate control assembly of claim 10, wherein the flexible cable (302) is coupled to the wastegate lever (206) at a distal end (308) of the flexible cable (302).

14. The wastegate control assembly of claim 13, wherein the distal end (308) of the flexible cable (302) includes a swaged fitting (312) adapted to couple the distal end (308) of the flexible cable (302) to the wastegate lever (206).

15. The wastegate control assembly of claim 14, wherein the swaged fitting (312) is adapted to rotate about a pin (318) adapted to couple the swaged fitting (312) to the wastegate lever (206).

16. The wastegate control assembly of claim 10, wherein the flexible cable (302) includes a ferrule connector (312) disposed at a distal end (308) of the flexible cable (302) and wherein the ferrule connector (304) is welded to the wastegate lever (206).

17. A system for closing a wastegate valve assembly of a turbocharger, the system comprising:
a wastegate lever (206) rotatably coupled to the wastegate valve assembly (124), the wastegate valve assembly (124) adapted to open into a second position when exhaust gas pressure within the turbocharger (100) exceeds a threshold, wherein the wastegate lever (206) is moveable along a non-linear path between a first position when the wastegate valve assembly (124) is closed and the second position when the wastegate valve assembly (124) is open;
a linear actuator (130) having an actuator shaft (202), the linear actuator (130) being operable to retract the actuator shaft (202) to close the wastegate valve assembly (124) in the first position and to extend the actuator shaft (202) to open the wastegate valve assembly (124) in the second position; and
a flexible cable (302) having a proximal end (306) coupled to the actuator shaft (202) and a distal end (308) coupled to the wastegate lever (206),
wherein the flexible cable (302) is held in tension by interaction between the actuator shaft (202) and the wastegate lever (206), and
wherein the flexible cable (302) is adapted to flex as the wastegate lever (206) moves along the non-linear path.

18. The system of claim 17, wherein the linear actuator (130) includes an electric linear actuator (130).

19. The system of claim 17, wherein the distal end (308) of the flexible cable (302) includes a swaged fitting (312) adapted to couple the distal end (308) of the flexible cable (302) to the wastegate lever (206).

20. The system of claim 19, wherein the swaged fitting (312) is adapted to rotate about a pin (318) adapted to couple the swaged fitting (312) to the wastegate lever (206).
